(19) United States
(12) Patent Application Publication
(10) Pub. No.: US 2010/0080939 A1
(43) Pub. Date: Apr. 1, 2010

(54) EMBLEM HAVING COLORED AND SILVERY SURFACES

(75) Inventors: Michael Kastrup, Bielefeld (DE); Joerg Tramberend, Wedohl (DE)

Correspondence Address: Oliver Intellectual Property LLC, P.O. Box 1670, Cotuit, MA, 02635, US

(73) Assignee: LINDEN GMBH & CO. KG, Lüdenscheid (DE)

(21) Appl. No.: 12/530,221

(22) PCT Filed: Jun. 17, 2008
(86) PCT No.: PCT/EP08/04859

§ 371 Date: Sep. 7, 2009

(30) Foreign Application Priority Data
Aug. 30, 2007 (DE) 10 2007 041347.7

(51) Int. Cl. B60R 13/00; B44C 3/00; B32B 38/14

(52) U.S. Cl. 428/31; 156/278; 156/245

(57) ABSTRACT

The invention relates to an emblem, in particular for a motor vehicle, having colored and silvery surfaces that are covered toward the outer side by a clear, transparent plastic layer, the clear, transparent plastic layer being made up of a load-carrying elastic plastic that carries, on the back side, the colored and silvery surfaces. The invention further relates to a method for manufacturing such an emblem.

### CROSS-REFERENCE TO RELATED APPLICATION(S)

The present application is a section 371 of PCT/EP08/04859, filed 17 Jun. 2008 and published as WO-2009-030294-A, and further claims priority from German application DE 10 2007 041 347.7, filed 30 Aug. 2007.

### FIELD OF THE INVENTION

The invention relates to an emblem, in particular for a motor vehicle, having colored and silvery surfaces that are covered toward the outer side by a clear, transparent plastic layer, and to a method for manufacturing such an emblem.

### BACKGROUND

Emblems for motor vehicles are known that are manufactured in such a way that a flat aluminum foil is imprinted with a colored lacquer, the colored lacquer leaving open sites through which the polished aluminum can appear in silvery fashion. The imprinted aluminum foil is then embossed, and is equipped on the front side with a clear plastic lacquer and on the back side with a plate-shaped plastic layer as a support layer or base. It has been found with these known emblems that the layers detach from one another when, as a result of a mechanical action on the front side (in particular due to stone impact), a hole is produced in the front side or the surrounding cut edge becomes unsealed, so that moisture can penetrate. The known emblem construction is particularly jeopardized thereby, since the emblem has little elasticity and therefore too little ability to absorb mechanical actions or to dissipate energy inputs.

### SUMMARY OF THE INVENTION

It is the object of the invention to improve an emblem of the kind cited initially in such a way that in a context of simple design and manufacture, delamination is reliably prevented.

This object is achieved according to the present invention in that the clear, transparent plastic layer is made up of a load-carrying elastic plastic that carries, on the back side, the colored and silvery surfaces.

### BRIEF FIGURE DESCRIPTION

FIG. 1 is a cross-sectional view of a preferred embodiment of the emblem of the invention.

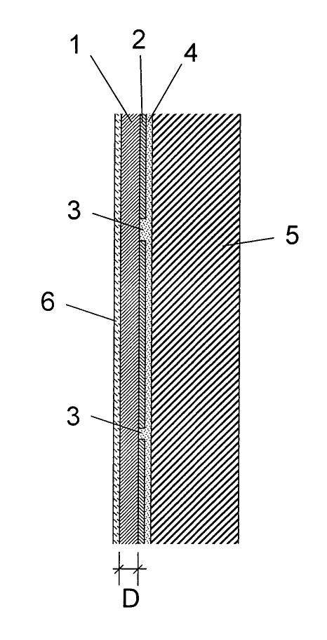

### DETAILED DESCRIPTION

An emblem constructed in this fashion, without an aluminum layer and thus made up only of plastic, can reliably nullify high-intensity energy impinging from the front—as happens, for example, with a stone impact—with no occurrence of fracture. An elastic, fracture-resistant emblem of this kind, which is made up only of plastic, is simple in terms of design, construction occurring in reverse sequence as compared with the existing art. Whereas with the previously known emblems, layers were applied onto the front side of a supporting aluminum foil, with the approach according to the present invention the colored layers are applied onto the back side of a load-carrying, elastic, clear, and transparent plastic layer.

It is particularly advantageous in this context if the clear, transparent plastic layer is equipped on the back side with a first colored layer that leaves areas exposed on the back side of the clear, transparent plastic layer; and that a second colored layer, in particular a chrome lacquer, which forms the silvery surfaces at the exposed sites, is applied onto the first colored layer.

It is also considered advantageous that a plate-shaped plastic layer is applied as a support layer, in particular as a base, on the back side of the clear, transparent plastic layer equipped with colored and/or silvery surfaces. A plastic structural component of this kind produces back-side support. This structural component is implemented in such a way that maximum energy absorption is enabled, and mounting on the bodywork of the vehicle is enabled.

It is further proposed in this context that the front side of the clear, transparent plastic layer be covered with an elastic, transparent plastic clearcoat in order further to improve strength and ability to nullify energy.

In order to achieve the object according to the present invention and in order to arrive at the advantages, a method for manufacturing an emblem of the kind cited initially is proposed, said method having the following method steps:
a first colored layer that leaves areas exposed is applied, in particular printed or sprayed, onto the back side of the clear, transparent plastic layer;
a silvery colored layer, in particular a chrome lacquer, that fills up the areas left exposed, is applied onto the first colored layer;
if necessary, a middle layer is applied in order to seal the chrome lacquer and for adhesion of the base located on the back side;
a plate-shaped plastic layer is applied, in particular injection-applied, onto the back side as a support layer, in particular as a base.

It is advantageous in this context if the clear, transparent plastic layer is injected and embossed in a mold. It is also preferably proposed that an elastic plastic clearcoat be applied, in particular painted, onto the front side of the clear, transparent plastic layer.

An exemplifying embodiment of the invention is depicted in the drawings in a cross section, in part, and at enlarged scale, and is described below in further detail.

The emblem comprises a plastic layer 1 made of a clear, transparent, elastic plastic which has a thickness such that it is load-carrying.

This plastic layer 1 has a thickness D from 0.3 to 0.6 mm, in particular from 0.4 to 0.5 mm. Polycarbonate (PC), polymethyl methacrylate (clear acrylic), or thermoplastic silicone elastomer is proposed as a plastic material, the elongation at fracture (elasticity) of said plastic layer 1 being in a range of at least 5%.

The plastic of this plastic layer 1 is preferably manufactured in a mold by injection molding, plastic layer 1 simultaneously being embossed. By means of such embossing, depending on the conditions that are defined, specific areas can be emphasized and very small material thicknesses having good visual properties can be produced.

A first colored layer 2 is applied, in particular printed or sprayed/injection-applied, onto the back side of plastic layer 1, said first colored layer preferably forming gaps in which it leaves areas 3 exposed. A second silvery colored layer 4 is then printed or sprayed onto the back side of first colored layer 2. A chrome lacquer is preferably used for this. This colored layer 4 also travels into the gaps or areas 3 left exposed, so that the silvery areas resulting therefrom are visible externally at these sites.

A plate-shaped plastic layer 5, which acts as a support layer and for energy absorption, in particular as a base, and which serves for mounting of the emblem, is applied, in particular injection-applied or cast, onto the back side of colored layer 4.

An elastic, transparent plastic clearcoat 6, which further enhances the scratch resistance of plastic layer 1 as well as energy absorption, can furthermore be applied onto the front side of plastic layer 1.

In addition, adhesion promoters can be used between colored layers 2, 4, and plastic layers 1, 5 in order to enhance adhesion.

What is claimed is:

1. An emblem, adapted for use on a motor vehicle, having colored and silvery surfaces that are covered toward an outer side thereof by a clear, transparent plastic layer (1), wherein
the clear, transparent plastic layer (1) is made up of a load-carrying elastic plastic that carries, on a back side thereof, the colored and silvery surfaces (2, 4).

2. The emblem according to claim 1, wherein
the clear, transparent plastic layer (1) is equipped on the back side with a first colored layer (2) that leaves areas (3) exposed on the back side of the clear, transparent plastic layer (1); and wherein a second colored layer (4), which forms the silvery surfaces at the exposed sites, is applied onto the first colored layer.

3. The emblem according to claim 1, wherein the clear, transparent plastic layer (1) comprises embossed areas.

4. The emblem according to claim 1, wherein
the clear, transparent plastic layer (1) is made of a material selected from the group consisting of polycarbonate, polymethyl methacrylate, and a thermoplastic silicone elastomer.

5. The emblem according to claim 1, wherein the clear, transparent plastic layer has a thickness in a range from 0.3 to 0.6 mm.

6. The emblem according to claim 1, wherein the elongation at fracture of the clear, transparent plastic layer (1) has a value of at least 5%.

7. The emblem according to claim 1, wherein the colored and silvery surfaces (2, 4) are printed or sprayed onto the back side of the clear, transparent plastic layer.

8. The emblem according to claim 1, wherein a plate-shaped plastic layer (5) is applied as a support layer, on the back side of the clear, transparent plastic layer (1) equipped with colored and/or silvery surfaces (2, 4).

9. The emblem according to claim 1, wherein the front side of the clear, transparent plastic layer (1) is covered with an elastic, transparent plastic clearcoat (6).

10. The emblem according to claim 1, wherein the colored and/or silvery surfaces (2, 4) are joined to the clear, transparent plastic layer (1), and the chrome lacquer is joined to the support layer, via an adhesion promoter.

11. The emblem according to claim 1, wherein it is free of any aluminum layer or aluminum foil.

12. A method of manufacturing an emblem, adapted for use on a motor vehicle, having colored and silvery surfaces that are covered toward an outer side thereof by a clear, transparent plastic layer (1),
comprising the steps of:
applying, onto the back side of the clear, transparent plastic layer, a first colored layer (2) while leaving local areas (3) of said back side exposed;
applying, onto the first colored layer (2), a silvery colored layer (4) which coats said local areas (3) left exposed by application of said first colored layer (2); and
applying, onto the back side of said clear, transparent plastic layer (1), a plate-shaped plastic layer (5) adapted to serve as a support layer.

13. The method according to claim 12, further comprising an additional step of
injection-embossing the clear, transparent plastic layer (1) in a mold.

14. The method according to claim 12, wherein an elastic plastic clearcoat (6) is applied onto the front side of the clear, transparent plastic layer (1).

15. The method according to claim 13, wherein an elastic plastic clearcoat (6) is applied onto the front side of the clear, transparent plastic layer (1).

16. The method of claim 12, wherein said step of applying a silvery colored layer comprises applying a chrome lacquer.

17. The method according to claim 12, further comprising applying, to said clear transparent layer (1), an adhesion promoter, prior to applying thereto additional layers.

18. The method according to claim 12, further comprising a preliminary step of forming said clear, transparent layer by injection-molding a material selected from the group consisting of polycarbonate, polymethyl methacrylate, and a thermoplastic silicone elastomer.

19. The emblem according to claim 2, wherein the clear, transparent plastic layer has a thickness in a range from 0.3 to 0.6 mm.

20. The emblem according to claim 2, further comprising an adhesion promoter applied between the clear, transparent plastic layer (1), and at least one other layer.
